(19) United States
(12) Patent Application Publication
(10) Pub. No.: US 2004/0019628 A1
(43) Pub. Date: Jan. 29, 2004

(54) System for remotely rendering content for output by a printer

(76) Inventors: Anish N. Puri, Westford, MA (US); Michael J. Vigneau, Stoneham, MA (US)

Correspondence Address: POLAROID CORPORATION, PATENT DEPARTMENT, 1265 MAIN STREET, WALTHAM, MA, 02451, US

(21) Appl. No.: 10/191,892

(22) Filed: Jul. 9, 2002

(51) Int. Cl. G06F 15/16

(52) U.S. Cl. 709/203; 709/231

(57) ABSTRACT

Techniques are disclosed for using the display rendering engine of a web browser to render content in a form suitable for output by a printer. The content is described by a content description, which may describe the content using any appropriate language, such as the Hypertext Markup Language (HTML). An output device description describes the printer according to input parameters of the web browser display rendering engine. The content description and the output device description are provided as inputs to the web browser display rendering engine, which generates the rendered content. The rendered content, once generated, may be captured, stored, and transmitted to the printer, which may print the rendered content. Some or all of the steps just described may be performed without displaying the rendered content on a display monitor. The web browser display rendering engine may be the display rendering engine of a conventional web browser.

### CROSS REFERENCE TO RELATED APPLICATIONS

This application is related to the following commonly-owned patent applications, each of which is hereby incorporated by reference in its entirety:

Ser. No. 09/870,536, filed May 30, 2001, entitled “Method and System for Remote Utilizing a Mobile Device to Share Data Objects”;

Ser. No. 09/870,538, filed May 30, 2001, entitled “Method and System for Generating a Permanent Record of a Service Provided to a Mobile Device”;

Ser. No. 09/870,561, filed May 30, 2001, entitled “Method and Apparatus for Printing Remote Images Using a Mobile Device and Printer”;

Ser. No. 10/022,924, filed Dec. 18, 2001, entitled “Method and Apparatus for Printing Remote Images Using a Network-Enabled Printer”;

Ser. No. 10/023,245, filed Dec. 18, 2001, entitled “Method and System for Generating a Permanent Record of a Service at a Remote Printer”; and

“Method and Apparatus for Providing Output from Remotely Located Digital Files Using a Remote Printer,” Serial No. aa/AAA,AAA (Attorney Docket No. 8531), filed concurrently herewith.

### FIELD OF THE INVENTION

The present invention relates to techniques for raster image processing and, more particularly, to techniques for rendering content for output by a printer.

### RELATED ART

The Internet, and in particular the World Wide Web (the “Web”), is increasingly being used to store and exchange information. Although the Web was originally only capable of storing and displaying textual information, the Web may now be used to store, display, print, and exchange a wide variety of textual, graphical, and audiovisual information. The Web is also increasingly being used to conduct commercial transactions, as part of what is referred to as “ecommerce.” Digital photography, for example, is becoming increasingly popular, spurred in large part by the advent of low-cost, high-quality digital cameras. An increasing number of web sites allow users to upload digital photographs and other digital images to the Web, whereby such images may subsequently be viewed, shared, and edited, as well as printed on conventional printers using computers connected to the Web using conventional Internet connections.

Furthermore, a variety of services are available on the Web for generating and obtaining content—such as maps, driving directions, news articles, movie tickets, and coupons—that may be downloaded and printed using conventional printers. Although some of this content may be downloaded and printed for free, some services charge a fee. It is often desirable that the user be able to access and print such content from a variety of locations. For example, it is desirable for a user in need of a street map to be able to obtain such a map while on the road, rather than solely from a fixed desktop computer.

For this and other reasons, mobile computing devices and devices with (wired and wireless) network communication capabilities are becoming increasingly popular. For example, both cellular telephones and mobile computing devices such as personal digital assistants (PDAs) are becoming increasingly widespread. Furthermore, small and lightweight mobile printers are becoming increasingly popular to facilitate printing of images and other information from a variety of locations. One reason that these devices are useful is that they may easily be transported and therefore used from locations other than the user's primary office or home, unlike conventional desktop computers and computer peripherals, which are typically fixed in a particular location.

Printing content obtained from the Web, whether using fixed computing devices (such as conventional desktop or laptop computers) or mobile computing devices, is often problematic for a variety of reasons. For example, printing content from the Web typically requires that the user connect a printer to a laptop or desktop computer, configure the printer to work with the computer, establish an Internet connection using the computer, obtain the content using a web browser executing on the computer, and execute a “Print” command. In addition to being tedious and time-consuming, errors may occur at a variety of stages in the process that may impede or prevent printing from completing successfully. Furthermore, in the case of mobile printers, the mobility of the printer is limited by the requirement that the printer be connected to a fixed computer before printing can occur.

Another problem with conventional methods for printing content obtained from the Web is that merely using the “Print” command of a conventional web browser to print content often produces printed output that is incomplete, incorrectly formatted, or otherwise sub-optimal. One reason for this is that content providers typically format content on their web sites to be optimized for display on a display monitor, not for output by a printer. Attempting to print such content directly to a printer using a web browser's “Print” command may result in sub-optimal output because, for example, the display monitor and printer have different margins, spatial resolutions, or color depths (e.g., the display monitor may be a color monitor while the printer may be a black-and-white printer). As a result, content providers must typically re-format their content to make it suitable for printing, thereby imposing an additional burden on the content provider and on the user, who must typically execute a special command or sequence of commands to print the desired content correctly on the printer.

Furthermore, content obtained from the Web may appear differently on the printed page depending on the particular operating system, web browser, and/or printer that is used. Such variations in printed output may be particularly problematic in cases where it is important that the printed output have particular characteristics (such as size, shape, or number of colors), as in the case of digital photographs, movie tickets, and coupons. A movie theater, for example, may require that all movie tickets have the same size and reject any ticket that is a different size. Furthermore, in the case of mobile printers having output media with small dimensions, it may be particularly important that the content be correctly rendered to fit within and be readable at such dimensions.

What is needed, therefore, are improved techniques for rendering content for output by printers, particularly mobile printers.

### SUMMARY

In one aspect of the present invention, techniques are provided for using the display rendering engine of a web browser to render content in a form that is suitable for output by a printer. The content is described by a content description, which may, for example, be written using the Hypertext Markup Language (HTML). An output device description describes the printer according to input parameters of the web browser display rendering engine. The content description and the output device description are provided as inputs to the web browser display rendering engine, which generates the rendered content.

In one embodiment, a content provider server provides the content description to a rendering server for rendering. The rendering server uses the web browser display rendering engine to render the content in a form suitable for output by the printer.

The rendered content, once generated, may be captured, processed, and stored in a file or other data structure in the memory of a computer or other computer-readable medium. The rendered content may be transmitted to the printer, which may print the rendered content. Some or all of the steps described above may be performed without displaying the rendered content on a display monitor.

Conventional web browsers typically include both a display rendering engine that is designed to render content for display on a display monitor and a print rendering engine that is designed to render content for output by a printer. The web browser display rendering engine that is used in various embodiments of the present invention may be a conventional web browser display rendering engine, such as the display rendering engine of any suitable version of Microsoft Internet Explorer® or Netscape Navigator®. The web browser display rendering engine may be a software component, such as a software component compliant with the Microsoft Component Object Model (COM).

Additional aspects and embodiments of the present invention and advantages thereof will be described in more detailed below.

### BRIEF DESCRIPTION OF THE DRAWINGS

FIG. 1 is a block diagram of a system for rendering content based on a description of the content and for printing the rendered content according to one embodiment of the present invention.

FIG. 2 is a block diagram of a rendering server for rendering content based on a description of the content according to one embodiment of the present invention.

FIG. 3 is a flow chart of a method that is used by a rendering server to render content for output by a printer according to one embodiment of the present invention.

### DETAILED DESCRIPTION

### High-Level Overview

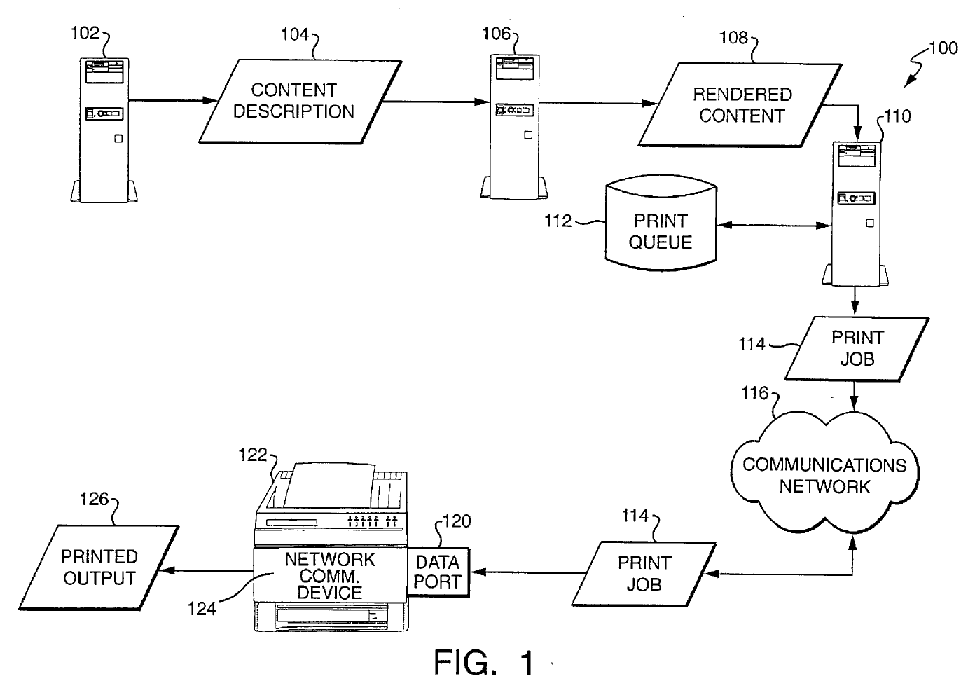

Referring to FIG. 1, a block diagram is shown of a system 100 for rendering content based on a description of the content and for printing the rendered content according to one embodiment of the present invention. More specifically, a content provider server 102 provides a content description 104 to a rendering server 106. The content description 104 may describe the content to be rendered using any appropriate language, such as the Hypertext Markup Language (HTML).

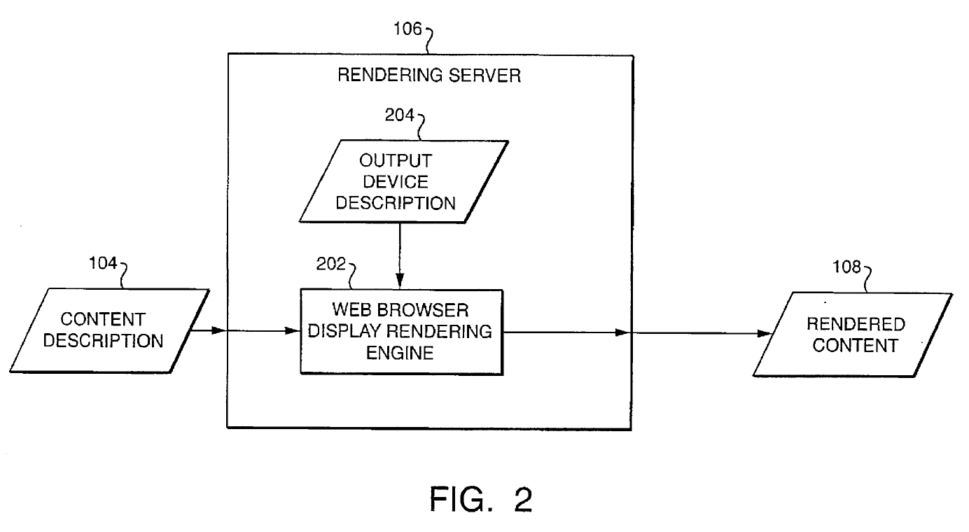

The rendering server 106 renders the content described by the content description 104 to generate rendered content 108. The rendered content 108 may take the form of a raster image, i.e., an image consisting of a two-dimensional array of pixels. Referring to FIG. 2, in one embodiment the rendering server 106 includes a display rendering engine 202 of a web browser (referred to herein as a “web browser display rendering engine”). The web browser display rendering engine 202 may, for example, be a conventional web browser display rendering engine, such as the display rendering engine of any suitable version of Microsoft Internet Explorer® or Netscape Navigator®. The web browser display rendering engine 202 may be a software component, such as a software component compliant with the Microsoft Component Object Model (COM). The display rendering engines of conventional web browsers are typically designed to render content for display on a display monitor. Such web browsers typically also include a print rendering engine for rendering content for output by a printer.

The rendering server 106 also includes an output device description 204 that describes a printer 122 according to input parameters of the web browser display rendering engine 202. If, for example, the web browser display rendering engine 202 is designed to render content for display on a display monitor, the web browser display rendering engine 202 may accept input parameters that define the particular display monitor on which rendered output is to be displayed. Such input parameters may correspond to display monitor features such as spatial resolution, dot pitch, and/or color depth. The output device description 204 may define input parameters that specify the appropriate features of the printer 122 rather than those of a display monitor. An example of one way in which this may be done is described in more detail below.

Referring again to FIG. 2, the rendering server 106 receives the content description 104 from the content provider server 102 and provides both the content description 104 and the output device description 204 as inputs to the web browser display rendering engine 202, which renders the content described by the content description 104 in accordance with the parameters defined by the output device description 204, thereby generating rendered content 108. The rendering server 106 may capture the rendered content 108 and store it in a file or other data structure in the memory of a computer or other computer-readable medium. Note that the rendering server 106 may generate the rendered content 108 without displaying the rendered content 108 on a display monitor.

Referring again to FIG. 1, the rendering server 106 may transmit the rendered content 108 to a print server 110, which may store the rendered content 108 in a print queue 112 associated with the printer 122. Additional rendered content may be stored in the print queue 112 using the techniques just described.

The print server 110 may transmit the rendered content 108, in the form of a print job 114, to the printer 122 over a communications network 116, such as the Internet. The print job 114 includes the rendered content 108 and possibly other information and/or commands for instructing the printer 122 to print the rendered content 108. The printer 122 may include a network communications device 124 (such as a modem) and connect to the communications network 116 through a data port 120. The printer 122 may print printed output 126 containing the rendered content 108 on an output medium (such as plain paper or thermal paper). Various ways in which the printer 122 may download and print the print job 114 are described in more detail in the above-referenced patent applications. Note that the entire process described above may be performed without displaying the rendered content on a display monitor.

### Role of Rendering Server in Overall System

Having described the operation of the system 100 in general terms, one embodiment of the system 100 will now be described in more detail. In the embodiment now described, the system 100 is used in conjunction with a service that may be used to purchase and print movie tickets.

In the present embodiment, the content provider server 102 is a server that is used by the ticket purchasing service. A user may purchase a ticket from such a service using, for example, a web site or an automated telephone system. Upon completion of the transaction, the service's content provider server 102 generates the content description 104, which describes the ticket purchased by the user. The content description 104 may, for example, be an HTML file that describes the content and layout of the ticket. The content description 104 may also include additional information, such as: (1) information identifying the content provider; (2) the date on which the content description 104 was generated; (3) the physical dimensions of the ticket; and (4) information (such as a unique device identifier) identifying the printer 122 by which the ticket is to be printed. Such additional information may, for example, be provided to the rendering server 106 in a separate file written according to the Extensible Markup Language (XML).

The rendering server 106 receives the content description 104 and renders the content described therein to generate rendered content 108, as described above. The rendering server 106 may perform additional image processing on the rendered content 108, such as compressing it, changing its color depth, or otherwise optimizing it for output on the printer 122 using information about the capabilities of the printer 122. Examples of such image processing are described in more detail in the above-referenced patent application entitled “Method and Apparatus for Printing Remote Images Using a Mobile Device and Printer.”

As described above, the rendering server 106 may transmit the rendered content 108 to the print server 110. The rendering server 106 may also transmit additional information, such as information identifying the printer 122, to the print server 110. The rendered content 108 and any additional information may be compressed and/or combined into a single file prior to being transmitted to the print server 110.

As described above, the print server 110 stores the rendered content 108 in a print queue 112 associated with the printer 122. Although only a single print queue 112 is shown in FIG. 1, the print server 110 may maintain print queues for multiple printers. Furthermore, the print server 110 may maintain an account for the printer 122 that includes additional information, such as a username and password of the printer's owner, other information identifying the printer's owner (such as the owner's name and address), and billing information. Maintenance and use of such accounts is described in more detail in the above-referenced patent applications.

As described above, the print server 110 may transmit the print job 114 (containing the rendered content 108) to the printer 122. In one embodiment, a user of the printer 122 initiates this transfer by, for example, physically connecting the printer 122 (through its data port 120) to the communications network 116 and pressing a “Print” button on the printer 122. In response, the printer 122 establishes a logical connection to the print server 110 over the communications network 116, and then downloads and prints all print jobs in the printer's print queue 112. Techniques by which such downloading and printing of images may be performed are described in more detail in the above-referenced patent applications.

As described above, the printer 122 processes the print job 114 to produce printed output 126 containing the rendered content 108. In the present embodiment, the printed output 126 is a printed movie ticket displaying information such as the movie's name and showtime, the theater at which the movie is playing, and the ticket price. The ticket may also include graphical information such as the movie theater's logo.

### Embodiment Using Internet Explorer Rendering Engine

In one embodiment, the web browser display rendering engine 202 is implemented using a version of the Microsoft Internet Explorer web browser ActiveX control named “WebBrowser” (referred to herein as the “WebBrowser control”). The WebBrowser control provides the functionality of a full-featured web browser, and includes, for example, both a display rendering engine and a print rendering engine for rendering HTML. In the embodiment that will now be described, the display rendering engine of the WebBrowser control is used to implement the web browser display rendering engine 202 and thereby to render content for output by the printer 122.

The WebBrowser control may be controlled by other software using interfaces that may be accessed using, for example, source code written in the C++ or Visual Basic programming languages. In the following description, examples will be provided that use the C++ programming language.

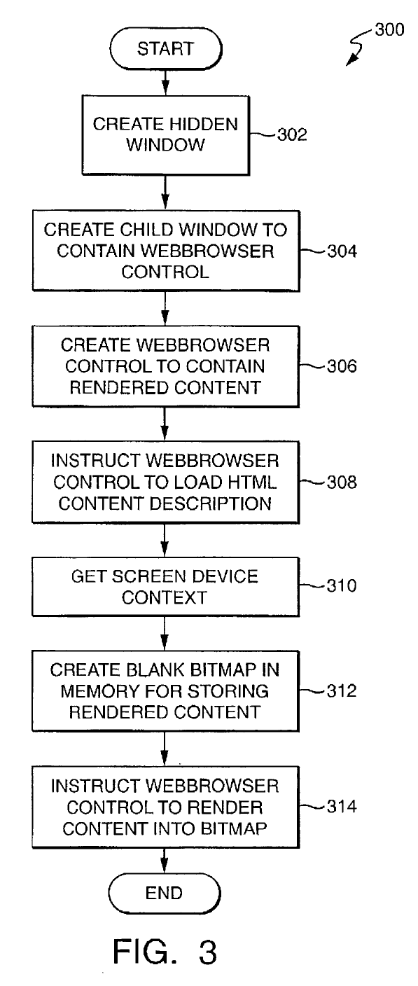

Referring to FIG. 3, a flowchart is shown of a method 300 that is used by the rendering server 106 to render content for output by the printer 122 according to one embodiment of the present invention. The rendering server 106 creates a hidden window using the Microsoft Windows CreateWindowEx( ) function (step 302). A hidden window is a data structure that is stored in the memory of the rendering server 106 and that may be manipulated by software in the same manner as other windows, but which is not displayed to the user. For example, when content is rendered within a hidden window, the hidden window's data structure is modified to reflect the rendered content, although the rendered content is not displayed onscreen.

The rendering server 106 creates a child window, within the hidden window, using the Microsoft Windows CreateWindowEx( ) function (step 304). The purpose of the child window is to store an instance of the WebBrowser control. The display area of the child window has the same dimensions as the desired dimensions of the rendered content 108. The child window may have additional components, such as scroll bars and a title bar, that make the total dimensions of the child window greater than the desired dimensions of the rendered content 108. Those of ordinary skill in the art will know how to calculate the total dimensions of the child window such that its display area is the same size as the rendered content 108.

The rendering server 106 creates, within the child window, an instance of the WebBrowser control having the same dimensions as the rendered content 108 (step 306). The rendering server 106 may create such a WebBrowser control by using, for example, the CWnd::CreateControl( ) function provided in the Microsoft Foundation Classes (MFC).

The rendering server 106 may use the QueryInterface function of the IUnknown interface of the WebBrowser control to retrieve the IWebBrowser2, IOleObject, and IViewObject2 interfaces of the WebBrowser control. In the present embodiment, the content description 104 is implemented using an HTML file. The rendering server 106 instructs the WebBrowser control to load this HTML file by calling the IWebBrowser2::Navigate2( ) function of the WebBrowser control with the name of the HTML file as a parameter (step 308).

The rendering server 106 renders the content described by the HTML file as follows. The rendering server 106 obtains a device context for the screen by calling the Microsoft Windows GetDCo function with a NULL window handle as a parameter (step 310). The rendering server 106 creates a blank Windows bitmap in memory that is compatible with (e.g., has the same color depth as) the screen device context obtained in step 310 by calling the Microsoft Windows function CreateCompatibleBitmap( ) with the previously-obtained device context as a parameter (step 312). The purpose of this bitmap is to store the rendered content 108. The bitmap may therefore have the same dimensions as the WebBrowser control.

The rendering server 106 instructs the WebBrowser control to render the content described in the content description 104 and to store the resulting rendered content 108 in the bitmap (step 314). The rendering server 106 may, for example, perform this step using the IViewObject2::Draw( ) function of the WebBrowser control.

At this point, the bitmap created in step 312 contains the rendered content 108. The rendering server 106 may copy and/or save some or all of the rendered content in a data structure in memory or in a file (prior to transmitting the rendered content 108 to the print server 110) using techniques that are well-known to those of ordinary skill in the art.

### Advantages

Various aspects and embodiments of the present invention have various advantages, which include but are not limited to the following.

Advantages of Server-Based Rendering

No Rendering by Printer Required

Using the rendering server 106, rather than the printer 122 or a conventional personal computer, to render the rendered content 108 is advantageous for a variety of reasons. For example, the printer 122 may be designed and manufactured more quickly, easily, and inexpensively if it does not require the hardware and/or software needed to render the rendered content 108. Furthermore, a printer without rendering hardware/software may be smaller than a printer with rendering hardware/software. These features are generally advantageous and are particularly advantageous if the printer 122 is to be small, mobile, and inexpensive.

To print the rendered content 108 contained within the print job 114, the printer 122 may include hardware and/or software for performing functions such as extracting the rendered content 108 from the print job 114 and decompressing the rendered content 108. Examples of techniques for performing these functions are described in more detail in the above-referenced patent applications. Performing functions such as extracting and decompressing the rendered content 108 may be performed more quickly than rendering the rendered content 108, thereby potentially allowing the printer 122 to print the rendered content 108 more quickly than a printer that needs to render the rendered content 108 based on the content description 104 before printing may begin. Furthermore, because the rendered content 108 is rendered before being transmitted to the printer 122, the printer 122 may print the rendered content 108 while the print job 114 (containing the rendered content 108) is being transmitted to the printer 122, thereby increasing the throughput of the printer 122, particularly in cases where the bandwidth of the connection between the printer 122 and the print server 110 is low.

No PC Required

A further advantage of using the rendering server 106 to generate the rendered content 108 is that the printer 122 need not be connected to a personal computer in order to print the rendered content 108. Rather, as described above, the printer 122 may communicate with the print server 110 without the use of a personal computer or other fixed computing device. In one embodiment, for example, the network communications device 124 is a modem, in which case the printer 122 (through its data port 120) may be connected to the print server 110 over a Plain Old Telephone Service (POTS) network, as described in more detail in the above-referenced patent application entitled “Method and Apparatus for Printing Remote Images Using a Network-Enabled Printer.” In another embodiment, the printer 122 may be connected to the communications network 116 by connecting the printer 122 (through its data port 120) to an Internet-enabled cellular telephone (not shown), as described in more detail in the above-referenced application entitled “Method and Apparatus for Printing Remote Images Using a Mobile Device and Printer.”

The ability to download the rendered content 108 to the printer 122 and to print the downloaded rendered content 108 without connecting the printer 122 to a personal computer increases the mobility of the printer 122, since the printer 122 may download and print the rendered content 108 from any location where the printer 122 may establish a connection to the print server 110.

Furthermore, elimination of the need to connect the printer 122 to a personal computer simplifies the process of printing from the point of view of the user. As described above, for example, the user may print the rendered content 108 simply by preparing the printer 122 to establish a connection to the print server 110 and pressing a “Print” button on the printer 122. The user need not perform additional steps such as connecting the printer 122 to a personal computer, configuring the printer 122 to work with the personal computer, or executing commands on the personal computer to cause it to download and print the rendered content 108 on the printer 122.

It should be appreciated that, despite the advantages of using the printer 122 without a personal computer, nothing herein should be interpreted to imply that the printer 122 may not be connected to and used in conjunction with a personal computer. Rather, the embodiments and advantages described herein in which the printer 122 is used to print the rendered content 108 without a personal computer are provided merely for purposes of example.

Ensures that Rendered Content is Tailored to the Printer

Another advantage of using the rendering server 106 to generate the rendered content 108 is that the rendering server 106 may ensure that the rendered content 108 is tailored to match the capabilities of the printer 122. A variety of content provider servers may, for example, transmit content descriptions to the rendering server 106 for rendering and subsequent printing by the printer 122. The rendering server 106 may use the techniques described above to rendering the content described by each such content description in a way that is consistent with the capabilities of the printer 122, such as its color depth and the dimensions of its output media. As a result, content provided by a variety of content provider servers may be formatted for printing by the printer 122.

If distinct entities control the rendering server 106 and the content provider server 102, such entities may contract with each other or otherwise agree that any content description provided to the rendering server 106 satisfy certain constraints that are required for the described content to be printed by the printer 122. For example, such entities may agree that any content description provided to the rendering server 106 specify content that fits within the page size of the output media used by the printer 122.

Advantages of HTML

Can Use Standard Web Browser Display Rendering Engines to Render

As described above, the content description 104 may be written using a standard language such as HTML. Using HTML has a variety of advantages. For example, HTML is a full-featured language that has been tested, refined, and improved over many years. HTML includes sophisticated features for separately specifying content and format and for precisely specifying the location of textual and graphical elements. Using HTML to implement the content description 104 enables the content description 104 and the rendering server 106 to take advantage of all of these and other features of HTML. For example, using HTML allows the content description 104 to precisely specify the layout of the content so that it may fit within the small dimensions of a mobile printer's output media.

Furthermore, using HTML allows the rendering server 106 to use the web browser display rendering engine 202 to generate the rendered content 108. The rendering server 106 in effect uses HTML as a page description language (PDL) and uses the web browser display rendering engine 202 as a raster image processor (RIP) to generate output for printing rather than for display on a display monitor. Because the web browser display rendering engine 202 may be a conventional software component provided as part of a conventional web browser, use of such a component eliminates the need to independently develop and maintain such a component. Furthermore, use of such a component enables the rendering server 106 to take advantage of all of the HTML-rendering features of a conventional web browser, and to take advantage of upgrades to such web browsers by replacing the web browser display rendering engine 202 with newer versions as they become available.

Furthermore, it may be advantageous to use a web browser's display rendering engine rather than its print rendering engine to render content in a form suitable for output by the printer 122. Although web browser print rendering engines are designed to render content for output by a printer, and are typically capable of parsing HTML to render images for output by a printer, using such print rendering images to render content for output by the printer 122 may have some drawbacks. For example, web browser print rendering engines typically perform additional processing on the content that they render, such as adding margins around the border of the content and adding headers and footers to the top and bottom of the page. Such additional processing may cause the appearance of the rendered content generated by a web browser print rendering engine to deviate from the appearance specified by the content description 104. Such deviations may be particularly significant in applications where it is important that the rendered content 108 appear exactly as specified by the content description.

Web browser display rendering engines, on the other hand, typically do not perform the kind of additional processing performed by web browser print rendering engines. Rather, web browser display rendering engines typically generate rendered content having an appearance that precisely or very closely matches the appearance specified by the corresponding content description. As a result, it may be preferable to use a web browser display rendering engine rather than a web browser print rendering engine to render content for output by a printer.

Easy for Content Providers to Produce

Using HTML to implement the content description 104 is also advantageous in situations where multiple content providers provide their content for display through web sites but are not yet equipped to provide their content to the rendering server 106 for printing. In such a situation, the content providers already possess the technology and ability to describe their content using HTML. For example, a content provider that provides street maps through a web site already possesses and uses technology for formatting such street maps using HTML, because HTML is the primary language that is used to describe web content. It may, therefore, be relatively easy for the content provider to modify its existing server to generate HTML content descriptions that are suitable for transmission to the rendering server 106 for rendering and subsequent printing on the printer 122. Such modification may involve, for example, modifying the street map's HTML code to match the printer's smaller output dimensions. Using HTML allows the content providers to use a single language to describe both content intended both for display and content intended for printing, thereby potentially decreasing the amount of time needed to generate and format content as well as potentially decreasing the amount of storage space needed to store content.

### Broadening Language

It should be appreciated that the various embodiments described above are provided merely for purposes of example and do not constitute limitations of the present invention. Rather, various other embodiments are also within the scope of the claims, such as the following.

Servers

Each of the servers described herein (such as the content provider server 102, the rendering server 106, and the print server 110) may be implemented in hardware, software, firmware, or any combination thereof. For example, the rendering server 106 may be implemented in software executing on a computer accessible over the communications network 116. None of the servers described herein need be a “server” according to a client-server architecture. Rather, the content provider server 102, rendering server 106, and print server 110 may be implemented using any means for performing the functions described herein. Furthermore, the rendering server 106 and print server 110 may both be implemented in a single server or be further divided into additional servers.

Rendering and Rendered Content

As used herein, the term “rendering” refers to generating graphical information from a description of the graphical information. For example, the generation of the rendered content 108 by the web browser display rendering engine 202 based on the content description 104 and the output device description 204 is an example of rendering. The rendered content 108 may, for example, be a rasterized image stored in a data structure in the memory of a computer or in a file (such as a GIF or JPEG file) stored on a computer-readable medium.

Although the rendered content 108 generated by the rendering server 106 may be in a final form suitable for printing by the printer 122, this is not required. Rather, the rendered content 108 may undergo additional processing by the print server 110 and/or printer 122 before the printed output 126 is generated.

Content

As used herein, the term “content” refers to any information, including but not limited to images, text, structured data, video, web pages, and any combination thereof.

Content Provider Server

Although the content provider server 102 may be implemented in whole or in part by computer, this is not required. The content description 104 may, for example, be handwritten in HTML by a human web designer. More generally, the content provider server 102 shown in FIG. 1 represents any source of the content description 104.

Content Description

Although in various embodiments described above the content description 104 is implemented using HTML, this is not a requirement of the present invention. Rather, the content description 104 may be implemented using any language suitable for provision to the web browser display rendering engine 202. The content description 104 may, for example, be implemented using HTML, XML, Extensible Hypertext Markup Language (XHTML), Cascading Style Sheets (CSS), Extensible Stylesheet Language (XSL), or any combination thereof.

Output Device Description

The output device description 204 may describe properties of the printer in any manner. For example, in the embodiment described above with respect to FIG. 3, the output device description 204 consists of the parameters that specify the desired dimensions and color depth of the rendered content 108. The output device description 204 may, however, describe the output device (e.g., the printer 122) in other ways, such as by using a data structure that stores parameters specifying properties of the output device.

Web browser display rendering engine

As used herein, the term “web browser display rendering engine” refers to the portion of a web browser that is designed to render content for output on a display monitor. As described above, web browsers typically include both a display rendering engine that is designed to render content for output on a display monitor and a print rendering engine that is designed to render content for output on an output medium by a printer. When a user uses a web browser to navigate to a web page, the web browser typically uses its display rendering engine to render the web page for display on a display monitor. When a user selects a web page for printing (such as by selecting a “Print” command from a drop-down menu), the web browser typically uses its print rendering engine to render the web page for output on an output medium by a printer.

The web browser display rendering engine 202 may, for example, be a software component such as a software component compliant with the Microsoft Component Object Model (COM). In one embodiment, the web browser display rendering engine 202 is a display rendering engine of a Microsoft Internet Explorer® web browser. The term “software component” as used herein refers to any software program or portion of a software program to which inputs may be provided to produce output. As used herein, the term “COM” refers to any version of COM for use on any computer platform. Similarly, as used herein, the term “Internet Explorer” refers to any version of the Internet Explorer web browser for use on any computer platform.

As shown in FIG. 2, the content description 104 and the output device description 204 are provided as inputs to the web browser display rendering engine 202. In the embodiment described above with respect to FIG. 3, the content description 104 is provided to the web browser display rendering engine 202 in step 308, and the output device description 204 is provided to the web browser display rendering engine 202 by instructing the web browser display rendering engine in step 314 to render the content into a bitmap having dimensions and a color depth that are compatible with the output device.

Communications Network

The communications network 116 may be any kind of communications network, such as a private intranet, the public Internet, a Plain Old Telephone Service (POTS) network, or a (digital or analog) wireless network. More generally, the communications network 116 may be any kind of coupling between the print server 110 and the printer, such as a serial or parallel cable or a wireless connection. Although only the print server 110 and the printer 122 are illustrated in FIG. 1 as communicating over the communications network 116, this is not a limitation of the present invention. Rather, other elements, such as the content provider server 102 and rendering server 106, may also communicate over the communications network 116 or over one or more other networks.

Printer

The printer 122 may be any device for producing printed output 126 on an output medium. The printer 122 may, for example, be a thermal printer, inkjet printer, or a laser printer. The printer 122 may be fixed or mobile.

The printer 122 can accept as input a raster image (consisting of a two-dimensional array of pixels) to be printed. Although the printer 122 may include an interpreter and/or rasterizer, it is not required to include such components because the rendering server 106 produces a raster image (in the form of the rendered content 108) that may be directly printed by a raster printer, such as printer 122.

The network communications device 124 may be any network communications device capable of communicating over the communications network 116. For example, the network communications device 124 may be an internal or external analog or digital modem, or a network interface card (NIC). The data port 120 may be a port of the network communications device 124. The network communications device 124 may be capable of communicating over the communications network 116 through another device, such as an Internet-capable cellular telephone.

The printer 122 is described herein as performing various functions, such as communicating with the print server 110 and printing the printed output 126. Such functionality may be implemented within the printer 122 in any manner, such as by using hardware, software, firmware, or any combination thereof. In general, a printer “controller” refers herein generally to any such subsystem(s) of the printer 122 that perform the functions described herein.

Display Monitor

As used herein, the term “display monitor” refers to any output device that provides visual output to a user on a dynamically-modifiable display. Display monitors include, but are not limited to, Cathode Ray Tube (CRT) displays and Liquid Crystal Displays (LCDs). A display monitor may be a distinct peripheral device (as is typically the case with display monitors that are used in conjunction with conventional desktop computers) or may be integrated with a computing device (as is typically the case with the displays of laptop computers and PDAs).

General Broadening Language

In general, the techniques described above may be implemented, for example, in hardware, software, firmware, or any combination thereof. The techniques described above may be implemented in one or more computer programs executing on a programmable computer including a processor, a storage medium readable by the processor (including, for example, volatile and nonvolatile memory and/or storage elements), at least one input device, and at least one output device. Program code may be applied to data entered using the input device to perform the functions described and to generate output information. The output information may be applied to one or more output devices.

Elements and components described herein may be further divided into additional components or joined together to form fewer components for performing the same functions.

Each computer program within the scope of the claims below may be implemented in any programming language, such as assembly language, machine language, a high-level procedural programming language, or an object-oriented programming language. The programming language may be a compiled or interpreted programming language.

Each computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output.

What is claimed is:

1. A computer-implemented method for rendering content described by a content description, the method comprising a step of:
(A) providing the content description and an output device description to a web browser display rendering engine to generate rendered content suitable for output by a printer, the rendered content comprising a raster image, wherein the output device description describes the printer according to at least one input parameter of the web browser display rendering engine.

2. The method of claim 1, wherein the content description is written in the Hypertext Markup Language (HTML).

3. The method of claim 2, further comprising steps of:
(B) capturing the rendered content generated by the web browser display rendering engine in the step (A); and
(C) storing the rendered content on a computer-readable medium.

4. The method of claim 2, further comprising a step of:
(B) transmitting the rendered content to the printer.

5. The method of claim 4, wherein the steps (A) and (B) are performed without displaying the rendered content on a display monitor.

6. The method of claim 4, further comprising a step of:
(C) at the printer, printing the rendered content.

7. The method of claim 2, wherein the web browser display rendering engine comprises a web browser display rendering engine that is designed to render content for display on a display monitor.

8. The method of claim 2, wherein the web browser display rendering engine comprises a software component compliant with the Microsoft Component Object Model.

9. The method of claim 1, wherein the web browser display rendering engine comprises a web browser display rendering engine of a Microsoft Internet Explorer web browser.

10. The method of claim 9, wherein the content description is written in the Hypertext Markup Language (HTML).

11. A computer-implemented method for rendering content described by a content description written in the Hypertext Markup Language, the method comprising steps of:
(A) providing the content description and an output device description to a web browser display rendering engine to generate rendered content suitable for output by a printer, the rendered content comprising a raster image, wherein the output device description describes the printer according to at least one input parameter of the web browser display rendering engine;
(B) capturing the rendered content generated by the web browser display rendering engine in the step (A);
(C) storing the rendered content on a computer-readable medium; and
(D) transmitting the rendered content to the printer.

12. A system for rendering content described by a content description, the rendering server comprising:
means for receiving the content description; and
means for providing the content description and an output device description to a web browser display rendering engine to generate rendered content suitable for output by a printer, the rendered content comprising a raster image, wherein the output device description describes the printer according to at least one input parameter of the web browser display rendering engine.

13. The system of claim 12, wherein the content description is written in the Hypertext Markup Language (HTML).

14. The system of claim 13, further comprising:
means for capturing the rendered content generated by the web browser display rendering engine; and
means for storing the rendered content on a computer-readable medium.

15. The system of claim 13, further comprising:
means for transmitting the rendered content to the printer.

16. The system of claim 15, wherein the web browser display rendering engine generates the rendered content without displaying the rendered content on a display monitor, and wherein the means for transmitting the rendered content transmits the rendered content without displaying the rendered content on a display monitor.

17. The system of claim 15, further comprising:
means for printing the rendered content.

18. The system of claim 13, wherein the web browser display rendering engine comprises a web browser display rendering engine that is designed to render content for display on a display monitor.

19. The system of claim 13, wherein the web browser display rendering engine comprises a software component compliant with the Microsoft Component Object Model.

20. The system of claim 11, wherein the web browser display rendering engine comprises a display rendering engine of a Microsoft Internet Explorer web browser.

21. The system of claim 20, wherein the content description is written in the Hypertext Markup Language (HTML).

22. A system for rendering content described by a content description written in the Hypertext Markup Language, the system comprising:
means for providing the content description and an output device description to a web browser display rendering engine to generate rendered content suitable for output by a printer, the rendered content comprising a raster image, wherein the output device description describes the printer according to at least one input parameter of the web browser display rendering engine;
means capturing the rendered content generated by the web browser display rendering engine;
means for storing the rendered content on a computer-readable medium; and
means for transmitting the rendered content to the printer.
